(19) United States
(12) Patent Application Publication
(10) Pub. No.: US 2010/0149640 A1
(43) Pub. Date: Jun. 17, 2010

(54) TUNABLE DIFFRACTION GRATING APPARATUS

(75) Inventors: Mun Cheol Paek, Daejeon (KR); Kwang Yong Kang, Daejeon (KR); Sang Kuk Choi, Daejeon (KR); Seung Hwan Lee, Gyeongsangnam-do (KR); Se Young Jeong, Gyeongsangnam-do (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/498,893

(22) Filed: Jul. 7, 2009

(30) Foreign Application Priority Data
Dec. 17, 2008 (KR) 10-2008-0128845

(51) Int. Cl. G02B 5/18

(52) U.S. Cl. 359/566

(57) ABSTRACT

Provided is a tunable diffraction grating apparatus including: a diffraction grating portion having a diffraction grating with an linearly variable grating interval, the diffraction grating being formed of an elastic member; a drive portion connected to the diffraction grating portion and applying a force to the diffraction grating portion to vary the grating interval; and a controller for controlling the drive portion to adjust the grating interval depending on a specific wavelength input from the exterior.

Therefore, the tunable diffraction grating apparatus can vary a grating interval of a diffraction grating using an elastic material so that a signal of a frequency bandwidth of THz can also be used. In addition, it is possible to simplify structure of the apparatus to reduce the manufacturing cost thereof.

### CROSS-REFERENCE TO RELATED APPLICATION

This application claims the benefit of Korean Patent Application No. 10-2008-0128845, filed Dec. 17, 2008, the disclosure of which is hereby incorporated herein by reference in its entirety.

### BACKGROUND

1. Field of the Invention

The present invention relates to a tunable diffraction grating apparatus used in optical measurement and analysis equipment such as a spectrum analyzer, a network analyzer, etc., and more particularly, to a tunable diffraction grating apparatus having elasticity and capable of varying a grating gap in an elasticity range.

2. Discussion of Related Art

In general, a diffraction grating is an optical element having certain patterns repeatedly disposed at predetermined intervals, which functions to vary a direction of incident light. Here, the direction of the incident light is determined depending on wavelengths of the light and intervals of grating patterns. The diffraction grating can distribute light having different wavelengths, for example, sunlight, into various angles depending on the wavelengths of the light, using the above optical properties. The diffraction grating functions similarly to a prism and is used to form monochromatic light or spectrum depending on necessities. While the prism uses optical characteristics in which refractive indices of light are varied depending on wavelengths, the diffraction grating uses diffraction conditions in which a specific wavelength moves at a specific angle.

In the conventional art, in order to obtain a diffraction angle of a specific direction with respect to a specific wavelength, a diffraction grating having maximum diffraction efficiency is used. Here, the maximum diffraction efficiency is determined by a specific shape of an individual grating, an optimal angle of incident light, etc., in addition to a grating interval. Therefore, provided that all conditions are the same, when exclusive diffraction for a specific wavelength is researched, a diffraction grating having only one grating interval depending on a specific condition can be used. However, when it is necessary to research diffraction of an unspecified wavelength range or find optimal conditions in an unknown wavelength range, various kinds of diffraction gratings may be needed.

In order to solve this problem, a diffraction grating having a variable grating angle has been proposed. However, since the grating interval of the diffraction grating must be at least ½ of the wavelength of the incident light, the grating interval of the diffraction grating must be varied in order to be applied to various wavelengths. Therefore, the conventional method of varying an angle direction of the diffraction grating cannot cover various kinds of wavelength.

A range of wavelength in which the diffraction grating is most widely used in an optical field is generally from 100 nm to 10 μm, i.e., an ultraviolet to infrared region. In addition, in recent times, research on terahertz (THz) has been developed and research on optical characteristics in the art has been generalized, and thus, a range that must be covered by the diffraction grating is about 30 μm in long-wavelength. Therefore, a diffraction grating that can cover the THz waves is needed.

Further, since the conventional diffraction grating must control an inclination angle of each grating, structure of the diffraction grating is complicated and manufacturing cost is increased, thus decreasing economical efficiency.

### SUMMARY OF THE INVENTION

The present invention is directed to a tunable diffraction grating apparatus capable of controlling a grating interval of a diffraction grating to be applied to various wavelengths.

The present invention is also directed to a tunable diffraction grating apparatus capable of simplifying structure and reducing manufacturing costs of the apparatus.

According to one aspect of the present invention, a tunable diffraction grating apparatus includes: a diffraction grating portion having a diffraction grating with an linearly variable grating interval, the diffraction grating being formed of an elastic member; a drive portion connected to the diffraction grating portion and applying a force to the diffraction grating portion to vary the grating interval; and a controller for controlling the drive portion to adjust the grating interval depending on a specific wavelength input from the exterior.

The diffraction grating portion may further include: a fixed support frame attached to a first side of the diffraction grating to fix the diffraction grating; a pair of movable shaft perpendicularly connected to both ends of the fixed support frame; and a movable support frame attached to a second side of the diffraction grating such that the diffraction grating can be linearly varied along the movable shafts, wherein the drive portion is connected to the movable support frame to linearly vary the grating interval of the diffraction grating.

The controller may determine a drive pressure value of the drive portion using a mapping table to vary the entire length of the diffraction grating, and the mapping table may store drive pressure values depending on materials of the diffraction grating.

The controller may control to vary the grating interval of the diffraction grating when the specific wavelength input from the exterior falls within an allowable range of an elastic coefficient.

The tunable diffraction grating apparatus may further include a measurement portion for measuring the grating interval of the diffraction grating and providing the measured grating interval to the controller.

In this case, the controller may detect a point at which arbitrarily input light is diffracted, and calculate a wavelength of the light on the basis of the grating interval provided by the measurement portion at the detected point.

The tunable diffraction grating apparatus may further include a display portion for displaying status information of the diffraction grating.

The predetermined wavelength may be a range of 100 nm to 30 μm.

### BRIEF DESCRIPTION OF THE DRAWINGS

The above and other features of the present invention will be described in reference to certain exemplary embodiments thereof with reference to the attached drawings in which:

FIG. 1 is a view showing incident light being reflected by a diffraction grating;

FIG. 2 is a view of a tunable diffraction grating apparatus in accordance with an exemplary embodiment of the present invention;

FIG. 3 is a view showing a varying grating interval of the diffraction grating in accordance with an exemplary embodiment of the present invention; and

FIGS. 4A and 4B are views showing an example of a diffraction grating portion and a drive portion of the tunable diffraction grating apparatus in accordance with an exemplary embodiment of the present invention.

### DETAILED DESCRIPTION OF EXEMPLARY EMBODIMENTS

The present invention will be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

The present invention provides a tunable diffraction grating apparatus having elasticity and capable of varying a grating interval within an elasticity range.

Hereinafter, a basic concept of a diffraction phenomenon will be described for the purpose of understanding of the present invention.

A diffraction phenomenon refers to a phenomenon in which constructive interference is generated when light moving in the same direction is divided into different directions and then combined so that a difference in path corresponds to an integer times the wavelength, and destructive interference is generated when the difference in path corresponds to an odd number times the half wavelength. Such a diffraction phenomenon is embodied according to Bragg's Law related to diffraction and reflection of light.

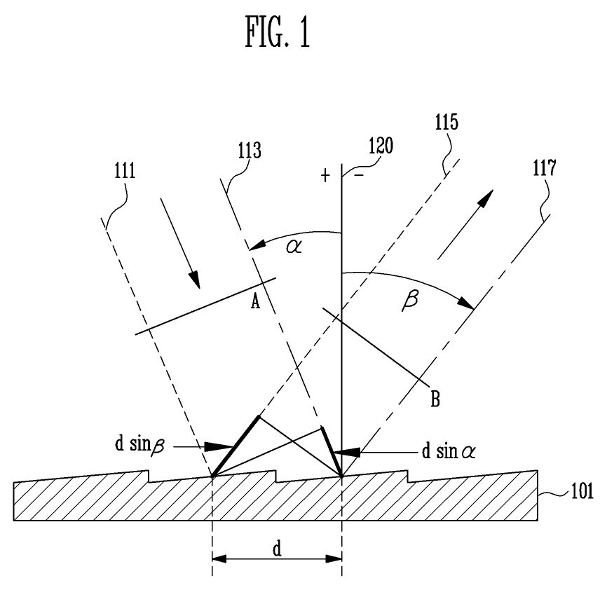

FIG. 1 is a view showing a basic concept of a diffraction grating, in which incident light is reflected by the diffraction grating.

Referring to FIG. 1, a diffraction grating 101 has grating patterns disposed at predetermined intervals d. Incident light has a wavelength λ.

The diffraction grating 101 satisfies diffraction conditions of Bragg's Law, which is represented by the following Formula 1:

d(sin α+sin β)=mλ [Formula 1]

Here, d is an interval of grating patterns, α is an angle of incident light 111 and 113 with respect to a vertical line 120 of a grating surface 120, β is an angle of diffraction light 115 and 117, m is the number of orders in diffraction, and λ is a wavelength of incident light. Therefore, it will be appreciated that elements related to diffraction conditions in a certain wavelength in Formula 1 are the interval d of the diffraction grating and the wavelength λ of incident light.

Referring again to FIG. 1, it will be appreciated that when the incident light 111 and 113 passes through grating patterns of the diffraction grating 101, the light reflected by the respective grating patterns has different paths according to propagating directions and thus diffraction occurs. Specifically, the incident light 111 and 113 having the wavelength λ enters the surface of the grating at an incident angle α and is diffracted at a diffraction angle β to satisfy Formula 1. Here, in consideration of a wave front B of the diffraction light 115 and 117 after the diffraction with respect to a wave front A of the parallel incident light 111 and 113, a path difference of two parallel lights, i.e., the incident light 111 and 113 and the diffraction light 115 and 117 will be represented as the following Formula 2:

d(sin α+sin β) [Formula 2]

This is because the incident angle α and the diffraction angle β have opposite signs due to their opposite directions with respect to the vertical line 120 of the grating surface. Therefore, it will be appreciated that since the diffraction conditions provide that the path difference of the Formula 2 is an integer times the wavelength of the incident light, Formula 1 is satisfied.

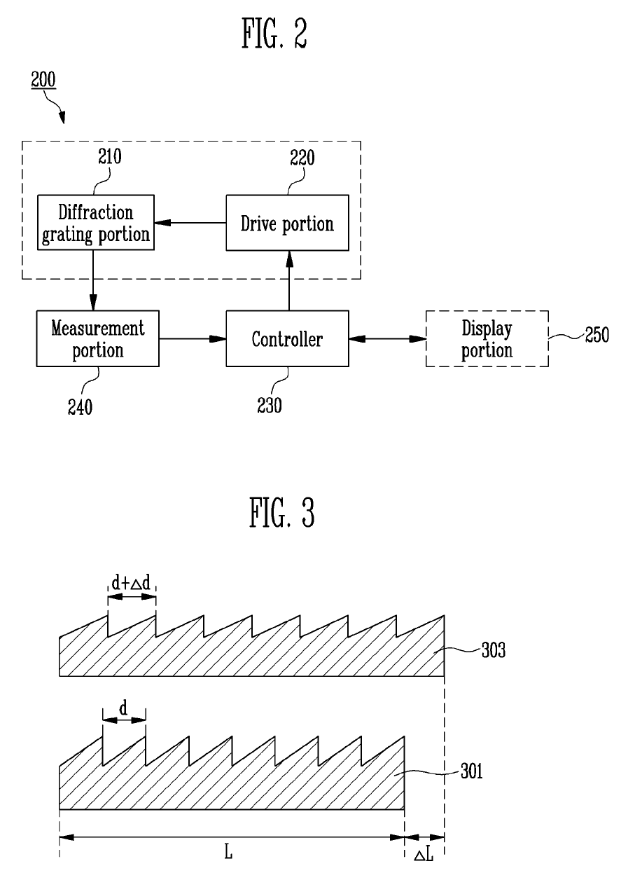

FIG. 2 is a block diagram of a tunable diffraction grating apparatus in accordance with an exemplary embodiment of the present invention.

Referring to FIG. 2, a tunable diffraction grating apparatus 200 includes a diffraction grating portion 210 formed of an elastic member and varying a grating interval of a diffraction grating, a measurement portion 240 for measuring the grating interval of the diffraction grating, a drive portion 220 for varying the entire length of the diffraction grating, and a controller 230 for controlling the drive portion 220 to vary the entire length of the diffraction grating depending on the grating interval used for a specific wavelength input from the exterior.

In addition, the tunable diffraction grating apparatus 200 may further include a display portion 250 for displaying current status information.

The diffraction grating portion 110 is configured to linearly vary the grating interval of the diffraction grating by using the diffraction grating formed of an elastic member. The elastic member may be a spring or a rubber-based material such as silicon rubber, etc. Here, a variation rate and a variation range of the grating interval are determined depending on elasticity and elastic limit of the material, and a linear variation range of the diffraction grating is determined within an elastic range of the material.

Hereinafter, variation in grating interval of the diffraction grating formed of an elastic member will be described with reference to FIG. 3.

FIG. 3 is a view showing a grating interval of the diffraction grating in accordance with an exemplary embodiment of the present invention being lengthened, illustrating states before variation 301 and after variation 303.

Referring to FIG. 3, when the entire grating length L of the diffraction grating is lengthened to L+ΔL, the grating interval d is increased to d+Δd. Since the diffraction grating is formed of a material with linearly variable length, an elongation ratio ΔL/L is equal to an elongation ratio Δd/d.

That is, when the grating interval of the diffraction grating is increased by 10%, the entire length L of the diffraction grating is controlled to be increased by 10%. Therefore, the tunable diffraction grating apparatus 200 in accordance with an exemplary embodiment of the present invention varies the entire length of the diffraction grating to control a grating interval of the diffraction grating.

Meanwhile, when the grating interval of the diffraction grating is increased, an inclination angle may be varied. However, since the inclination angle of the diffraction grating is related only to diffraction efficiency and affects little variation in grating interval, it will not be considered in this invention.

Referring again to FIG. 2, the controller 230 determines the grating interval depending on a specific wavelength input from the exterior to control the entire length of the diffraction grating. That is, when the grating interval of the diffraction grating is determined, the controller 230 controls the entire length of the diffraction grating with the same ratio as the determined grating interval.

In addition, the controller 230 may receive the measured information from the measurement portion 240 to determine whether the varied grating interval of the diffraction grating is accurate.

Meanwhile, the controller 230 may calculate the wavelength of the incident light. That is, the controller 230 may move the grating interval of the diffraction grating with respect to the incident light and detect a grating interval at a light diffraction point to calculate the wavelength of the light.

The measurement portion 240 may measure the grating interval of the diffraction grating to transmit it to the controller 230 when the grating interval of the diffraction grating is varied.

The drive portion 220 varies the entire length of the diffraction grating to linearly vary the grating interval of the diffraction grating under the control of the controller 230. Here, the controller 230 determines a drive pressure value of the drive portion 220 in order to vary the entire length depending on the predetermined grating interval, and transmit the drive pressure value to the controller 220 to control the entire length of the diffraction grating.

Here, the drive pressure value is varied depending on a material of the diffraction grating. Therefore, the controller 230 may determine the drive pressure value using a table that pre-stores drive pressure values depending on materials of the diffraction grating.

The drive portion 220 may be embodied as a means for uniformly driving a power source. For example, the driving portion 220 may uniformly move the diffraction grating portion 210 using a mechanical force of a motor, etc., or an electrical stimulus using a piezoelectric material, etc.

The display portion 250 may be additionally provided to display status information of the tunable diffraction grating apparatus 200. The status information may include a grating interval, a usable frequency wavelength, etc. In addition, the display portion 250 may receive wavelength information of usable light from a user to transmit the information to the controller 230.

Hereinafter, the structure of the diffraction grating portion 210 in accordance with an exemplary embodiment of the present invention will be described.

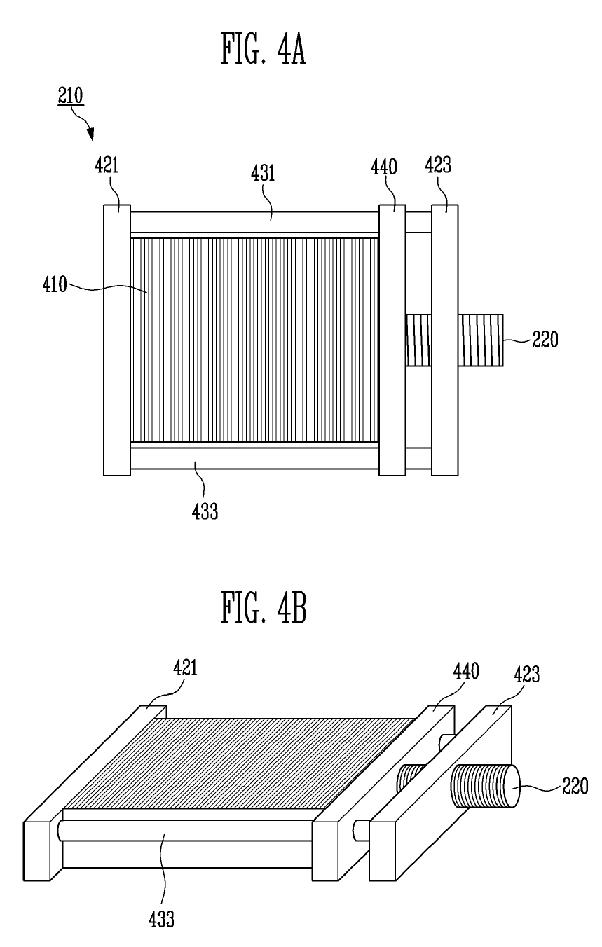

FIGS. 4A and 4B are a plan view and a perspective view showing an example of the diffraction grating portion and the drive portion of the tunable diffraction grating apparatus in accordance with an exemplary embodiment of the present invention.

Referring to FIGS. 4A and 4B, a diffraction grating portion 210 includes a diffraction grating 410 formed of an elastic material, a fixed support frame 421 attached to one side of the diffraction grating 410 to fix the diffraction grating 410, movable shafts 431 and 433 perpendicularly connected to both ends of the fixed support frame 421, and a movable support frame 440 attached to the other side of the diffraction grating 410 such that the diffraction grating 410 can be linearly varied along the moving shafts 431 and 433.

Here, the diffraction grating portion 210 may be configured such that a second fixed support frame 423 is connected to one end of each of the movable shafts 431 and 433 to more securely fix the diffraction grating 410.

In addition, the drive portion 220 is connected to the movable support frame 440 to linearly vary the diffraction grating 410.

The diffraction grating 410 is formed of an elastic material such as a spring or a rubber-based material such as silicon rubber, so that the grating interval can be linearly varied. Here, a variation rate and a variation range of the grating interval of the diffraction grating are determined depending on elasticity and elastic limit of a material, and a linear variation range of the diffraction grating varies within the elastic limit of the material.

Since the light wavelength range that can be diffracted by the diffraction grating is two times a maximum grating interval, when the grating interval of the diffraction grating is increased as in the present invention, the diffraction grating can diffract light having a wavelength corresponding to two times the increased length.

The drive portion 220 is configured to vary the entire length of the diffraction grating 410 to linearly vary the grating interval. While the drive portion 220 in this embodiment has a screw structure, various means for linearly and uniformly moving the diffraction grating 410 may be implemented. For example, the screw structure may be driven using a mechanical force of a motor, etc., or an electric stimulus of a piezoelectric material, etc.

As can be seen from the foregoing, a tunable diffraction grating apparatus in accordance with an exemplary embodiment of the present invention can vary a grating interval of a diffraction grating using an elastic material to cover from 100 nm to a long-wavelength of 30 μm so that a signal of a frequency bandwidth in THz can also be used. In addition, it is possible to simplify structure of the apparatus to reduce manufacturing costs thereof.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A tunable diffraction grating apparatus comprising:
a diffraction grating portion having a diffraction grating with an linearly variable grating interval, the diffraction grating being formed of an elastic member;
a drive portion connected to the diffraction grating portion and applying a force to the diffraction grating portion to vary the grating interval; and
a controller for controlling the drive portion to adjust the grating interval depending on a specific wavelength input from the exterior.

2. The tunable diffraction grating apparatus according to claim 1, wherein the diffraction grating portion further comprises:
a fixed support frame attached to a first side of the diffraction grating to fix the diffraction grating;
a pair of movable shaft perpendicularly connected to both ends of the fixed support frame; and
a movable support frame attached to a second side of the diffraction grating such that the diffraction grating can be linearly varied along the movable shafts,
wherein the drive portion is connected to the movable support frame to linearly vary the grating interval of the diffraction grating.

3. The tunable diffraction grating apparatus according to claim 1, wherein the controller determines a drive pressure value of the drive portion using a pre-stored mapping table to vary the entire length of the diffraction grating, and the mapping table stores drive pressure values depending on materials of the diffraction grating.

4. The tunable diffraction grating apparatus according to claim 1, wherein the drive portion varies the entire length of the diffraction grating using a mechanical force.

5. The tunable diffraction grating apparatus according to claim 1, wherein the drive portion varies the entire length of the diffraction grating using an electrical stimulus.

6. The tunable diffraction grating apparatus according to claim 1, wherein the diffraction grating is formed of a rubber-based material.

7. The tunable diffraction grating apparatus according to claim 1, wherein the controller controls to vary the grating interval of the diffraction grating when the specific wavelength input from the exterior falls within an allowable range of an elastic coefficient.

8. The tunable diffraction grating apparatus according to claim 1, further comprising a measurement portion for measuring the grating interval of the diffraction grating and providing the measured grating interval to the controller.

9. The tunable diffraction grating apparatus according to claim 8, wherein the controller detects a point at which arbitrarily input light is diffracted, and calculates a wavelength of the light on the basis of the grating interval provided by the measurement portion at the detected point.

10. The tunable diffraction grating apparatus according to claim 1, further comprising a display portion for displaying status information of the diffraction grating.

11. The tunable diffraction grating apparatus according to claim 1, wherein the predetermined wavelength falls within a range of 100 nm to 30 μm.
